(19) United States
(12) Patent Application Publication
(10) Pub. No.: US 2012/0306361 A1
(43) Pub. Date: Dec. 6, 2012

(54) EL ELEMENT CONTAINING A SEMITRANSPARENT METAL FOIL AND PRODUCTION METHOD AND USE

(75) Inventors: Thilo-J. Werners, Leverkusen (DE); Michael Heite, Olpe (DE); Thomas-Hermann Kessler, Bensheim (DE); Klaus Reinartz, Koln (DE)

(73) Assignee: Bayer MaterialScience AG, Leverkusen (DE)

(21) Appl. No.: 13/332,935

(22) Filed: Dec. 21, 2011

Related U.S. Application Data
(63) Continuation of application No. 12/518,122, filed on Nov. 3, 2009, now abandoned.

(30) Foreign Application Priority Data
Dec. 7, 2006 (DE) 102006057653.5

(51) Int. Cl. H05B 33/12; H05B 33/10

(52) U.S. Cl. 313/506; 445/23

(57) ABSTRACT

The invention relates to foil element constructed from a) an at least partly transparent carrier foil, component A, which contains at least one cold-stretchable foil material which is provided with optional graphical representations, b) a semitransparent reflecting layer B, c) an at least partly transparent foil comprising at least one cold-stretchable foil material, component C, d) at least one electroluminescent element, component D, applied onto the at least partly transparent foil C, e) a protective layer, component EA, or a foil, component EB. The invention further relates to the use of the foil element as a decorative panel or a display element for vehicles, for forming safety-belt panels or warning-indication panels in vehicles, for forming warning-indication panels in buildings, and for forming housing elements for mobile electronic instruments or stationary electronic instruments, or for forming a small or household appliance or for forming a keyboard.

### CROSS-REFERENCE TO RELATED APPLICATIONS

This application a continuation application of application Ser. No. 12/518,122 filed Nov. 3, 2009 which is incorporated by reference. Application Ser. No. 12/518,122 is a national stage application (under 35 U.S.C. §371) of PCT/EP2007/010599, filed Dec. 6, 2007, which claims benefit of German application 10 2006 057 653.5, filed Dec. 7, 2006.

### BACKGROUND OF THE INVENTION

The present invention relates to a foil element constructed from an at least partly transparent carrier foil, a semitransparent reflecting layer, a further at least partly transparent foil, an electroluminescent element and a protective layer or further foil, to a process for producing the foil element, to a three-dimensionally deformed foil element that is capable of being produced by isostatic high-pressure deformation of the foil element according to the invention, to a process for producing the three-dimensionally deformed foil element according to the invention, and to the use of the foil element according to the invention and of the three-dimensionally deformed foil element according to the invention for forming decorative panels or covers or display elements for land vehicles, watercraft and aircraft, for forming safety-belt panels or warning-indication panels in land vehicles, watercraft and aircraft, and warning-indication panels in buildings, and for forming housing elements for mobile and stationary electronic instruments, and for forming a keyboard.

Electroluminescent luminous surfaces for mobile or stationary electronic instruments are known in the state of the art. Such electroluminescent luminous surfaces are ordinarily used as built-in components for the back lighting of display devices and operating elements. Conventional electroluminescent luminous surfaces exhibit a polyester film as carrier material with an electrically conducting, largely transparent layer which has been vapour-deposited in a sputtering process. In addition, such electroluminescent luminous surfaces generally contain further layers, for example layers that contain electroluminescent crystals, a counter-electrode and protective layers. Since layers that are employed in the state of the art for producing electroluminescent luminous surfaces frequently have a brittle character or do not withstand a deforming process at high temperatures, the conventional display devices are generally of flat design, which—for example, in the case of objects that exhibit three-dimensional geometries—can result in an impairment of the perceptibility of information data and to an impairment of operability.

Three-dimensional electroluminescent displays have therefore already been proposed in the state of the art.

DE-A 44 30 907 relates to a three-dimensional electroluminescent display with a transparent disc, with a light-transmitting layer applied on at least one side of the disc, with at least one electroluminescent lamp applied alongside the light-transmitting layer and with a substrate moulded onto the electroluminescent lamp and onto the disc for the purpose of forming an integral three-dimensional electroluminescent display. Production of the three-dimensional electroluminescent display is effected starting from a preformed disc. However, it is further mentioned that the disc may also be postformed, i.e. that the three-dimensional electroluminescent display is formed by conventional processes prior to the forming of the substrate. DE-A 44 30 907, however, does not contain any further information with respect to suitable customary processes.

DE-A 102 34 031 relates to an electroluminescent luminous surface that exhibits the structure of a capacitor with two electrodes situated in parallel, at least one of which is of transparent design, with a luminous substance that is capable of being excited by an electric field and that is arranged between the electrodes. The electroluminescent luminous surface contains, moreover, a carrier layer provided with information data, which is manufactured from a freely deformable foil material or from a hard material that exhibits a three-dimensionally deformed surface, the carrier layer exhibiting in congruent manner, corresponding to its deformation at least in the region of its information data, a coating with a first electrically conductive layer, with a pigment layer, with an insulating and reflecting layer, with a top electrode and also with an optional protective layer. Production of the electroluminescent luminous surface is effected by the carrier layer consisting of the freely deformable foil material or of a hard material that has previously been brought into a three-dimensionally deformed surface shape firstly being imprinted with information data and subsequently being provided with a first electrically conductive layer, with a pigment layer, with an insulating and reflecting layer, with a back electrode and also with an optional protective layer. After this, the three-dimensionally deformed foil body can be in-mould decorated with a plastic material, in order to produce a carrier body. In the case where a carrier layer is employed consisting of a freely deformable foil material, a deformation of the imprinted foil body provided with the further layers named above can be effected, thermoforming being mentioned in DE-A 102 34 031 by way of single deformation procedure.

WO 03/037039 relates to a three-dimensional electroluminescent display which comprises a main body and an electroluminescent device. The electroluminescent device consists of a foil and an electroluminescent apparatus, the surface of the foil facing towards the electroluminescent apparatus being provided with motifs to be displayed. The electroluminescent apparatus comprises a front electrode and a back electrode, between which a dielectric is located. The front electrode is assigned to the layer reproducing the motif and is integral with this layer. Within the surface of the electroluminescent device a feed source is arranged which contacts the electrodes of the electroluminescent device. The main body is made of a suitable plastic that can advantageously be processed in an injection-moulding process. For the purpose of producing the three-dimensional electroluminescent display, the electroluminescent device is firstly produced. In this connection, firstly the foil that serves as carrier for the electroluminescent apparatus is provided. Subsequently the electroluminescent device is reformed by being thermoformed, embossed, hollow-embossed or solid-embossed, the reforming preferably being effected by thermoforming. After the deformation, the main body is assigned to the rear of the electroluminescent device, for example by in-mould decoration of the electroluminescent device with a material that is suitable for this purpose.

German application DE 10 2006 031 315, which is older in priority and not a prior publication, entitled “3D-EL-HDVF-Element und Herstellungsverfahren und Anwendung” [3D EL HPDF element and production method and application], relates to a three-dimensionally deformed foil element constructed from an at least partly transparent carrier foil A consisting of at least one cold-stretchable foil material, at least one electroluminescent element B applied onto the carrier foil, and a protective layer CA or foil CB which is capable of being produced by isostatic high-pressure deformation of a planar foil element constructed from components A, B and C at a process temperature below the softening-temperature of component A of the foil element. One peculiarity of the three-dimensionally deformed foil element is that three-dimensional deformation is effected of the foil element containing all the desired components—i.e. that, for example, the electroluminescent element is applied prior to a three-dimensional deformation. The three-dimensionally deformed foil element is distinguished, in particular, by a positionally accurate application of the electroluminescent element and, where appropriate, of existing graphical representations.

For decorative reasons, the provision of electroluminescent foil elements is desirable that, in the case where no current is flowing, exhibit a metallic-looking—i.e. light-reflecting—surface (metal optics). In this way, the further layers of the foil element are not visible when the current is switched off. As soon as the current is switched on, the foil element is intended to glow, preferably in colour. The provision of foil elements of such a type with a metallic-looking surface can be achieved by the foil elements exhibiting a semitransparent reflecting layer. Foil elements of such a type are known in the state of the art.

DE-A 42 08 044 relates to an electroluminescent luminous strip which contains an electroluminescent luminous element that exhibits a layer consisting of a semitransparent film and is encapsulated in a moisture-impervious material. The luminous strip includes a semitransparent metallic film layer which directly abuts the electroluminescent luminous layer. Production of the electroluminescent luminous strip is effected by so-called extrusion. A three-dimensional deformation of the luminous strip disclosed in DE-A 42 08 044 is not effected.

DE-A 41 26 051 relates to a security element that exhibits two electrically conductive layers and a layer having electroluminescent properties, arranged between the electrically conductive layers. According to a preferred embodiment, two plastic films are provided—on one side in each instance—with a thin aluminium layer, and an electroluminescent material based on zinc sulfide is printed in strip form onto one of the metal layers. Subsequent to this, the plastic films are laminated in such a way that the electroluminescent material comes to be situated between the metallic layers. Finally, the laminated sheet that is obtained is cut into filaments corresponding to the electroluminescent strips. According to DE-A 41 26 051, a three-dimensional deformation of the security elements is not effected.

U.S. Pat. No. 3,497,750 relates to a flexible electroluminescent lamp that contains a dielectric layer made of plastic, in which electroluminescent phosphorus particles in finely divided form are embedded, as well as a light-transmitting electrode, to one surface of which a film of an electrically conductive material is bonded. The light-transmitting electrode is coated with a light-transmitting plastic film which extends beyond the sides of the phosphorus/plastic layer. Moreover, on the other side of the phosphorus/plastic layer a metallised plastic film is applied which likewise extends beyond the sides of the phosphorus/plastic layer. The projecting portions of the plastic layers are fused together, so that the metallised plastic film serves both as electrode and as protective jacket for the electroluminescent lamp. A three-dimensional deformation of the electroluminescent lamp is not mentioned in U.S. Pat. No. 3,497,750.

JP-A 2000-348870 relates to a stratiform electroluminescent (EL) display comprising an EL element, at least constructed from a surface-electrode layer, a luminescent layer, an insulating layer and a back electrode layer, the surface-electrode layer being formed from a thin metal film with a transmission in respect of visible light from 5% to 60%. A three-dimensional deformation of the EL element disclosed in JP-A 2000-348870 is not mentioned.

In the case of the electroluminescent layered structures known in the state of the art, which exhibit a semitransparent reflecting layer, the semitransparent reflecting layer directly abuts the electroluminescent luminescent layer and forms—generally together with an at least partly transparent plastic layer—the (at least partly) transparent electrode.

A disadvantageous aspect of this layered structure is that a non-destructive three-dimensional deformation of such a layered structure is not possible. The object of the present invention is therefore the provision of a layered structure that is suitable for electroluminescence and that is three-dimensionally deformable in non-destructive manner.

### BRIEF SUMMARY OF THE INVENTION

This object is achieved by the provision of a foil element constructed from
a) an at least partly transparent carrier foil, component A, consisting of at least one cold-stretchable foil material, which is provided with graphical representations where appropriate.
b) a semitransparent reflecting layer, component B,
c) an at least partly transparent foil, component C, consisting of at least one cold-stretchable foil material,
d) at least one electroluminescent element, component D, applied onto the at least partly transparent foil C, containing the following components
   da) an at least partly transparent electrode, component DA,
   db) where appropriate, a first insulating layer, component DB,
   dc) a layer, component DC, containing at least one luminous substance that is capable of being excited by an electric field,
   dd) where appropriate, a further insulating layer, component DD,
   de) a back electrode, component DE,
e) a protective layer, component EA, and/or a foil, component EB.

### DETAILED DESCRIPTION OF THE INVENTION

The invention relates to a foil element constructed from
a) at least partly transparent carrier foil, component A, which comprise at least one cold-stretchable foil material which is provided with optional graphical representations,
b) a semitransparent reflecting layer B,
c) at least partly transparent foil comprising at least one cold-stretchable foil material, component C,
d) at least one electroluminescent element, component D, applied onto the at least partly transparent foil C, containing the following components
   da) an at least partly transparent electrode, component DA,
   db) optionally a first insulating layer, component DB,
   dc) a layer, component DC, containing at least one luminous substance that is capable of being excited by an electric field,
   dd) optionally a further insulating layer, component DD, and
   de) a back electrode, component DE,
e) a protective layer, component EA, or a foil, component EB.

Furthermore, the foil element according to the invention includes, preferentially by way of component DF, a conductor track or several conductor tracks, component DF, for the electrical contacting both of component DA and of component DE. The conductor track or conductor tracks may have been applied in the form of a silver bus, preferentially produced from a silver paste, and are preferentially generated by screen printing. Prior to the application of the silver bus, a graphite layer may possibly also be applied, likewise preferentially by screen printing.

In a preferred embodiment of the present invention, the foil element according to the invention is therefore constructed from
a) an at least partly transparent carrier foil, component A, consisting of at least one cold-stretchable foil material, which is provided with graphical representations where appropriate,
b) a semitransparent reflecting layer, component B,
c) an at least partly transparent foil, component C, consisting of at least one cold-stretchable foil material,
d) at least one electroluminescent element, component D, applied onto the at least partly transparent foil C, containing the following components
   da) an at least partly transparent electrode, component DA,
   db) where appropriate, a first insulating layer, component DB,
   dc) a layer, component DC, containing at least one luminous substance that is capable of being excited by an electric field,
   dd) where appropriate, a further insulating layer, component DD,
   de) a back electrode, component DE,
   df) a conductor track or several conductor tracks, component DF, for electrical contacting both of component DA and of component DE,
e) a protective layer, component EA, and/or a foil, component EB.

In addition to the stated layers (components A, B, C, D and E), the three-dimensionally deformed foil element according to the invention may exhibit further layers. What is essential is that on both sides of the semitransparent reflecting layer B an at least partly transparent foil (A and C) is located in each instance, foils A and C directly abutting the semitransparent reflecting layer B. It has been found that foil elements that exhibit the structure according to the invention—i.e. in particular, that exhibit in each instance an at least partly transparent foil A and C on both sides of the semitransparent reflecting layer B—are three-dimensionally deformable in non-destructive manner, in particular by isostatic high-pressure deformation of the foil element according to the invention, which is ordinarily of planar design, generally at a process temperature below the softening-temperature of components A and C of the foil element.

### Component A

The foil element according to the invention contains an at east partly transparent carrier foil, component A, consisting of at least one cold-stretchable foil material which is provided with graphical representations where appropriate.

The expression ‘at least partly transparent carrier foil’ is to be understood to mean both transparent carrier foils and those which are translucent but not totally transparent. In this connection, a transparent foil exhibits a transmission of visible light of 100%, whereas a partly transparent foil exhibits a transmission of visible light of <100%, generally 5 to <100%, preferably 10 to 99%, particularly preferably 50 to 99%. In accordance with the invention, the carrier foil is constructed from at least one cold-stretchable foil material. This is necessary, in order that production of the three-dimensionally deformed foil element can be carried out by isostatic high-pressure deformation at a process temperature below the softening-temperature of component A. Suitable cold-stretchable foil materials are named, for example, in EP-A 0 371 425. Both thermoplastic and thermosetting at least partly transparent cold-stretchable foil materials may be employed. Cold-stretchable foil materials are preferably employed that exhibit slight resilience or no resilience at room temperature and at service temperature. Particularly preferred foil materials are selected from at least one material from the group consisting of polycarbonates, preferably polycarbonates based on bisphenol A, for example the Makrofol® brands marketed by Bayer MaterialScience AG (BMS), polyesters, in particular aromatic polyesters, for example polyalkylene terephthalates, polyamides, for example PA 6 or PA 6,6 types, high-strength ‘aramide films’, polyimides, for example the foils marketed under the trade name Kapton based on poly(diphenyl oxide pyromellitimide), polyarylates, organic thermoplastic cellulose esters, in particular the acetates, propionates and acetobutyrates thereof, for example foil materials that are marketed under the trade name Cellidor®, and polyfluorohydrocarbons, in particular the copolymers formed from tetrafluoroethylene and hexafluoropropylene known under the trade name FEB, which are available in transparent form. Preferred foil materials of the carrier foil are selected from polycarbonates, for example the Makrofol® brands marketed by Bayer MaterialScience AG, polyesters, in particular aromatic polyesters, for example polyalkylene terephthalates, and polyimides, for example the foils marketed under the trade name Kapton® based on poly(diphenyl oxide pyromellitimide). In quite particularly preferred manner, polycarbonates based on bisphenol A are employed as foil materials, in particular foils having the designation Bayfol® CR (polycarbonate/polybutylene-terephthalate foil), Makrofol® TP or Makrofol® DE produced by Bayer MaterialScience AG.

The at least partly transparent carrier foil that is employed in accordance with the invention may exhibit surfaces that are provided with a sateen finish or that are rough on one side or surfaces that are highly lustrous on both sides. The layer thickness of the at least partly transparent carrier foil that is employed in accordance with the invention generally amounts to 40 μm to 2000 μm. With higher layer thicknesses, the abrupt reforming that is carried out in the course of the isostatic high-pressure deformation frequently brings about an embrittlement of the material. A carrier foil with a layer thickness from 50 μm to 500 μm is preferably employed, particularly preferably 100 μm to 400 μm, quite particularly preferably 150 μm to 375 μm.

In a preferred embodiment, depending on the use of the foil element according to the invention the at least partly transparent carrier foil is provided with graphical representations. In this connection it may be a question of information symbols, so that letters, numerals, symbols or pictograms, for example, are visible on the surface of the three-dimensionally deformed foil element. In the case of the graphic design, it is preferably a question of a typographical graphic design, in particular a colour overprint. In a particularly preferred embodiment, the carrier foil that is employed in accordance with the invention is provided with graphical representations in the form of opaque or translucent colour overprints. These colour overprints may be effected by arbitrary processes known to a person skilled in the art, for example by screen printing, offset lithography, serigraphy, rotary printing, gravure printing or flexographic printing, which are all customary and known in the state of the art. The graphic design is preferably effected by application of ink by means of screen printing, since pigmented inks with high layer thickness and good deformability can be applied by means of screen printing.

The printing inks employed for the purpose of graphic design have to be sufficiently deformable under the conditions of the isostatic high-pressure deformation. Suitable inks, in particular screen-printing inks, are known to a person skilled in the art. Inks with a plastic ink-carrier, for example based on polyurethane, may be employed, for example. These screen-printing inks exhibit outstanding adhesion to the foil material of the carrier foil that is employed in accordance with the invention. In particularly preferred manner, screen-printing inks based on aqueous dispersions of aliphatic polyurethanes are employed. Suitable inks are, for example, obtainable under the trade name AquaPress PR® from Pröll, Weissenburg. Further suitable screen-printing inks are those based on high-temperature-resistant thermoplastics, in particular screen-printing inks having the trade name Noriphari from Pröll, Weissenburg,

If the graphic symbols are placed on the rear of foil C, then by reason of the semitransparent reflecting layer B in a preferred embodiment these graphical representations are visible only when the current is switched on. If, on the other hand, the current is switched off, ‘only’ a metallic surface is visible.

But the graphic symbols may also be overprinted on the front of foil A, so that these graphical representations are permanently visible. The back lighting of the symbols or of the entire surface then serves for better recognisability in darkness.

### Component B

In the case of component B, it is a question of a semitransparent reflecting layer. In this connection, the expression ‘semitransparent reflecting layer’ in the sense of the present application is to be understood to mean a layer that partly reflects visible light and is partly transmitting in respect of visible light. In this connection, the expression ‘visible light’ is to be understood to mean light with a minimal wavelength of about 360 nm and with a maximal wavelength of about 830 nm, as is known to a person skilled in the art.

The semitransparent reflecting layer B preferably exhibits a transmission in respect of visible light of, in general, 5% to 60%, preferably 10% to 40%.

The semitransparent reflecting layer may be, for example, a metal layer or a semitransparent polymeric printable reflecting layer.

The layer thickness of the semitransparent reflecting layer B generally amounts to 1 nm to 500 nm, preferably 50 nm to 200 nm, when use is made of a metal layer, and 500 nm to some 5 pm to 10 pm, when use is made of a semitransparent polymeric printable reflecting layer.

Suitable metals that may form the semitransparent reflecting layer are known to a person skilled in the art. Preferably employed by way of metal forming the semitransparent reflecting layer is at least one metal selected from the group consisting of aluminium, magnesium, tin, gold, silver, copper, zinc, nickel, chromium, cobalt, manganese, lead, titanium, iron and tungsten. Particularly preferred metals forming the semitransparent reflecting layer are aluminium and/or chromium. Mixtures of several metals or one or more metallic printing inks may also be employed.

Ordinarily the semitransparent reflecting layer B is firstly applied onto the at least partly transparent carrier foil A. However, it is likewise possible firstly to apply the semitransparent reflecting layer onto the at least partly transparent foil C. Application may be effected by the processes known to a person skilled in the art that are suitable to generate a preferably uniform thin metal foil without surface irregularities. Suitable processes are, for example, PVD processes (physical vapour deposition), for example evaporation processes such as thermal evaporation (vapour deposition), electron-beam evaporation, laser-beam evaporation, arc evaporation and molecular-beam epitaxy, sputtering or ion plating, CVD processes (chemical vapour deposition), such as thermal CVD, plasma-assisted CVD and metallo-organic CVD (MOCVD) or calendering.

Suitable process conditions of the aforementioned processes are known to a person skilled in the art.

### Component C

In the case of component C, it is a question of an at least partly transparent foil consisting of at least one cold-stretchable foil material. In order to enable a three-dimensional deformation of the foil element according to the invention by the process of isostatic high-pressure deformation, foil C is preferably constructed from the materials named with respect to component A. In this connection, the materials of components A and C in the foil element according to the invention may be the same or different (preferably selected in each instance from the materials named with respect to the carrier foil A). In particularly preferred manner, foils A and C in a foil element are constructed in each instance from the same materials.

In a particularly preferred embodiment, the foil material of the carrier foil A and the foil material of foil C are selected from at least one material selected from the group consisting of polycarbonates, polyesters, polyamides, polyimides, polyarylates, organic thermoplastic cellulose esters and polyfluorohydrocarbons, in quite particularly preferred manner polycarbonates, polyesters and polyimides.

Further preferred materials for foil C are the materials named with respect to the carrier foil A.

In an, in particular, quite particularly preferred embodiment, the foil material of the carrier foil A and the foil material of foil C are polycarbonates, in particular polycarbonates based on bisphenol A, for example foils having the designation Bayfol®CR (polycarbonate/polybutylene-terephthalate foil), Makrofol®TP or Makrofol®DE from Bayer MaterialScience AG.

The thickness of foil C likewise corresponds to the preferred thickness stated with respect to the carrier foil A.

Application of the second foil (A or C) onto the second surface of the semitransparent metal foil B already applied onto the first foil (A or C) can be effected by processes known to a person skilled in the art, for example by adhesive bonding. Suitable processes and adhesives are known to a person skilled in the art.

### Component D

The foil element according to the invention contains at least one electroluminescent element applied onto foil C by way of component D.

The electroluminescent element contains the following components
da) an at least partly transparent electrode, component DA,
db) where appropriate, a first insulating layer, component DB,
dc) a layer, component DC, containing at least one luminous substance that is capable of being excited by an electric field,
dd) where appropriate, a further insulating layer, component DD,
de) a back electrode, component DE.

Furthermore, the electroluminescent element that is used in accordance with the invention preferentially includes by way of component DF a conductor track or several conductor tracks for electrical contacting both of component DA and of component DE. The conductor track or conductor tracks may have been applied in the form of a silver bus, preferentially produced from a silver paste, and are preferentially generated by screen printing. Prior to the application of the silver bus, a graphite layer may possibly also be applied, preferentially by screen printing.

In a preferred embodiment of the present invention, the electroluminescent element that is used in accordance with the invention is constructed from
da) an at least partly transparent electrode, component DA,
db) where appropriate, a first insulating layer, component DB,
dc) a layer, component DC, containing at least one luminous substance that is capable of being excited by an electric field,
dd) where appropriate, a further insulating layer, component DD,
de) a back electrode, component DE,
df) a conductor track or several conductor tracks, component DF, for electrical contacting both of component DA and of component DE.

The electroluminescent element may exhibit further components in addition to the components named above. For example, further layers may be present between the back electrode, component DE, and the, where appropriate, one further insulating layer, component DD (or, if the insulating layer is not present, between component DE and component DC). In this case, component DD (or, if the latter is not present, component DC) may be adjoined by a further structure comprising an at least partly transparent electrode, a further layer containing at least one luminous substance that is capable of being excited by an electric field, and, where appropriate, a further insulating layer. This structure may, where appropriate, be repeated once more, in which case the final component of the structure adjoins the back electrode, component DE.

Suitable electroluminescent elements are known to a person skilled in the art. It has been found that foil elements that exhibit at least one electroluminescent element that is employed in accordance with the invention can be deformed in non-destructive manner by means of isostatic high-pressure deformation, so that three-dimensionally deformed foil elements can be obtained from the foil elements according to the invention by isostatic high-pressure deformation.

To a person skilled in the art it is known that the at least one electroluminescent element that is employed in accordance with the invention is contacted with a source of current. In general, for this purpose the at least one electroluminescent element exhibits electrical terminals which are conducted to a lateral edge of the foil element according to the invention and are contacted there with a source of current by means of contacting aids. Suitable contacting aids are, for example, crimping, clamping, electrically conducting adhesive, riveting, screwing and other means known to a person skilled in the art. The drive of the electroluminescent element can be effected in conventional manner known to a person skilled in the art.

In general, the electroluminescent element is operated with alternating current. In order to generate the alternating current, electroluminescent inverters (EL inverters) are employed. Suitable EL inverters are known to a person skilled in the art and are commercially obtainable.

In the case of the electroluminescent elements that are employed in the foil element according to the invention by way of component D, it is generally a question of thick-film electroluminescent elements which are operated with alternating current (thick-film AC EL elements). An advantage of these thick-film AC EL elements is that relatively high voltages of, in general, higher than 100 volts peak-to-peak, preferably higher than 100 volts peak-to-peak to 140 volts peak-to-peak, at several 100 Hz right up to the kHz range (1000 Hz), preferably 250 Hz to 800 Hz, particularly preferably 250 Hz to 500 Hz, are used and there is practically no ohmic power loss in the course of formation of the layer, component DC (dielectric layer), containing at least one luminous substance that is capable of being excited by an electric field. The electrical conductivity of the electrodes (components DA and DE) should therefore be as uniform as possible, but no particular current loading arises. Preferably, however, efficiently conducting bus bars are employed, in order to reduce drops in voltage.

In general, operation of the electroluminescent elements (component B) employed in the foil element according to the invention is effected at a brightness of 10 cd/m² to 500 cd/m², preferably 10 cd/m² to 100 cd/m². In this case, when use is made of microencapsulated ZnS electroluminophores in the layer containing at least one luminous substance that is capable of being excited by an electric field, service half-lives of, in general, at least 2000 hours are achieved. As a matter of principle, the operation of electroluminescent elements of such a type with an AC voltage having a harmonic curve shape is to be preferred. Transient voltage pulses should be avoided. Especially the procedure of switching on and off is preferably configured in such a manner that no superelevated voltage pulses damage the layer containing at least one luminous substance (dielectric) that is capable of being excited by an electric field and, where appropriate, likewise damage individual luminous substances (electroluminophores). The reduction in brightness with the service life, the so-called half-life—that is to say, the time up until a decline to one half of the initial brightness, can be balanced by readjustment of the voltage supply, or, where appropriate, by readjustment of the frequency. In this connection, for the purpose of readjusting the emission of light, use may be made, for example, of an external photodiode which measures the electroluminescent emission. With the change in frequency the emission colour of the electroluminescent emission can also be influenced within certain ranges.

In another preferred embodiment of the present invention, the foil element according to the invention may contain an LED element in addition to the at least one electroluminescent element. It is preferably a question of an SMD LED element. Suitable LED elements are known to a person skilled in the art and are commercially obtainable.

A further subject of the present invention is therefore a foil element constructed from components A, B, C, D and E and additionally at least one LED element, preferably at least one SMD LED element, by way of component F.

The SMD LED modular units are preferably arranged on the rear of the foil elements constructed from components A, B, C, D and E, for example by adhesive bonding by means of a process known to a person skilled in the art and by means of adhesives known to a person skilled in the art.

LED elements ordinarily exhibit a point-shaped emission of light of very high luminance and—for example, behind an indication field arranged in translucent and signal-effective manner—can therefore generate higher luminous intensities than planar electroluminescent elements. Foil elements according to the invention that exhibit LED elements can therefore be used effectively as an alarm-signal element. In addition, in another preferred embodiment the translucent luminous fields are provided with diffuser elements by means of printing technology and/or dispenser technology, so that the SMD LED element exhibits a broad radiation characteristic and in this way can be used as an optical signal for an alarm condition, such as, for example, the display of an excessive temperature or of too little oil or the failure of the ABS braking system and such like. Suitable diffuser elements are known to a person skilled in the art and are commercially obtainable.

The electroluminescent element employed in accordance with the invention exhibits an at least partly transparent electrode. In this connection, the expression ‘at least partly transparent electrode’ is to be understood to mean an electrode that may be totally transparent or an electrode that may be translucent but not totally transparent.

The at least partly transparent electrode is generally a planar electrode that is constructed from or more inorganically-based or organically-based electrically conductive materials. Suitable at least partly transparent electrodes that can be employed in accordance with the invention are all electrodes known to a person skilled in the art for producing electroluminescent elements that are not damaged by the deformation for producing the three-dimensionally deformed foil element according to the invention by means of isostatic high-pressure deformation. Consequently, although conventional indium tin oxide (ITO) sputtered layers on thermally stabilised polyester foils, which are mentioned in the state of the art, are suitable in principle, they are not preferred. Use is preferably made of polymeric electrically conductive highly transparent coatings or design-specific screen-printing layers.

The at least partly transparent electrode that is employed in accordance with the invention is consequently preferably selected from the group consisting of ITO screen-printing layers, ATO (antimony tin oxide) screen-printing layers, non-ITO screen-printing layers (the term ‘non-ITO’ encompassing all screen-printing layers that are not based on indium tin oxide (ITO))—that is to say, intrinsically conductive polymeric layers with, ordinarily, nanoscale electrically conductive pigments, for example the ATO screen-printing pastes having the designations 7162E or 7164 from DuPont, intrinsically conductive polymer systems such as the Orgacon system from Agfa, the Baytron poly(3,4-ethylenedioxythiophene) system from H.C. Starck GmbH, the system from Ormecon designated as organic metal (PEDT conductive polymer, polyethylenedioxythiophene), conductive coating systems or printing-ink systems from Panipol OY and, where appropriate, with highly flexible binding agents, for example based on PU (polyurethanes), PMMA (polymethyl methacrylate), PVA (polyvinyl alcohol), modified polyaniline. The at least partly transparent electrode of the electroluminescent element Baytron poly(3,4-ethylenedioxythiophene) system from H.C. Starck GmbH is preferably employed.

In accordance with the invention, 10 to 90 wt. %, preferably 20 to 80 wt. %, particularly preferably 30 to 65 wt. %, in each case relative to the total weight of the printing paste, Baytron P, Baytron PH, Baytron P AG, Baytron P HCV4, Baytron P HS, Baytron PH, Baytron PH 500, Baytron PH 510 or arbitrary mixtures thereof are preferably used for the purpose of formulating a printing paste for producing the partly transparent electrode DA. Dimethyl sulfoxide (DMSO), N,N-dimethylformamide, N,N-dimethylacetamide, ethylene glycol, glycerol, sorbitol, methanol, ethanol, isopropanol, N-propanol, acetone, methyl ethyl ketone, dimethylaminoethanol, water or mixtures of two or three or more of the named solvents may be used as solvent. The quantity of solvent in the printing paste may vary within wide ranges. Accordingly, in one formulation, according to the invention, of a paste 55 to 60 wt. % solvent may be included, whereas in another formulation according to the invention about 35 to 45 wt. % of a solvent mixture consisting of two solvents are used. Furthermore, Silquest A187, Neo Rez R986, Dynol 604 and/or mixtures consisting of two or more of these substances may be included by way of interface additive and adhesion activator. The quantity thereof preferentially amounts to 0.3 to 2.5 wt. %, relative to the total weight of the printing paste.

By way of binding agent, UD-85, Bayhydrol PR340/1, Bayhydrol PR135 or arbitrary mixtures thereof, preferentially in quantities from approximately 0.5 to 6 wt. %, preferably 3 to 5 wt. %, may be contained in the formulation. In the case of the polyurethane dispersions that are employed in accordance with the invention, which form the binding agent for the conductive layer after drying of the layer, it is preferentially a question of aqueous polyurethane dispersions.

A formulation, particularly preferred in accordance with the invention, of a printing paste for producing the partly transparent electrode DA contains:

| Substance | Content/wt. % | Content/wt. % |
|---|---|---|
| Baytron P HS (HC Starck) | 33.0 | 48.0 |
| Silquest A187 (OSi Specialties) | 0.4 | 0.5 |
| N-methylpyrrolidone | 23.7 | 14.4 |
| Diethylene glycol | 26.3 | 20.7 |
| Proglyde/DMM | 12.6 | 12.4 |
| UD-85 (Lanxess) | 4 | 4 |

Departing from the formulations stated above for the partly transparent electrode DA, the following ready-made, commercially obtainable printing pastes named here in exemplary manner can also be employed in accordance with the invention as finished formulations: the Orgacon EL-P1000, EL-P3000, EL-P5000 or EL-P6000 series from Agfa, preferably the EL-P3000 and EL-P6000 series (in particular for deformable uses).

In general, the at least partly transparent electrode of the electroluminescent element is directly connected to the at least partly transparent foil C.

The electroluminescent element that is employed in accordance with the invention contains, in addition to the at least partly transparent electrode, component DA, a layer containing at least one luminous substance that is capable of being excited by an electric field, by way of component DC. The layer is generally applied onto a, where appropriate, existing first insulating layer, component DB, or, if this layer is not present, onto the at least partly transparent electrode. In the case of the luminous substance (luminophore), capable of being excited by an electric field, in the layer (component DC), it is preferably a question of ZnS, which is generally doped with copper, manganese and/or phosphorus, preferentially with copper and/or manganese, and is also preferentially co-doped with at least one of the elements selected from the group consisting of chlorine, bromine, iodine and aluminium.

The ZnS crystals are preferably microencapsulated with a transparent, thin layer, in order to increase the service life of the luminous substance. This microencapsulation is known from the state of the art and is known to a person skilled in the art. Accordingly, EP-A-455 401 discloses, for example, a microencapsulation consisting of titanium dioxide or dialuminium trioxide. In this case each ZnS particle is provided substantially completely with a largely transparent, continuous metal-oxide coating. The layer, component DC, contains the aforementioned, where appropriate doped, ZnS crystals, preferably microencapsulated as described above, preferentially in a quantity from 40 to 90 wt. %, preferably from 50 to 80 wt. %, particularly preferably 55 to 70 wt. %, in each case relative to the weight of the paste. By way of binding agents, use may be made of one-component and preferably two-component polyurethanes. Preferred in accordance with the invention are materials produced by Bayer MaterialScience AG, for example the lacquer raw materials of the Desmophen and Desmodur series, preferentially Desmophen and Desmodur, or the lacquer raw materials of the Lupranate, Lupranol, Pluraco or Lupraphen series produced by BASF AG. By way of solvent, use may be made of ethoxypropyl acetate, ethyl acetate, butyl acetate, methoxypropyl acetate, acetone, methyl ethyl ketone, methyl isobutyl ketone, cyclohexanone, toluene, xylene, solvent naphtha 100 or arbitrary mixtures of two or more of these solvents in quantities of preferentially 1 to 50 wt. %, preferably 2 to 30 wt. %, particularly preferably 5 to 15 wt. %, in each case relative to the total mass of the paste. Moreover, 0.1 to 2 wt. % additives for improving the flow behaviour and the levelling may be included. Examples of levelling agents are Additol XL480 in Butoxyl in a mixing ratio from 40:60 to 60:40. By way of further additives, 0.01 to 10 wt. %, preferably 0.05 to 5 wt. %, particularly preferably 0.1 to 2 wt. %, in each case relative to the total mass of the paste, rheological additives may be included, which lessen the settling behaviour of pigments and fillers in the paste, for example BYK 410, BYK 411, BYK 430, BYK 431 or arbitrary mixtures thereof.

Ordinarily in the case of the layer (component DC) it is a question of dielectric material. This material may be, for example, ZnS, generally doped with copper, manganese and/or phosphorus, preferentially with copper and/or manganese, and also preferentially co-doped with at least one of the elements selected from the group consisting of chlorine, bromine, iodine and aluminium, or a mixture of ZnS, generally doped with copper, manganese and/or phosphorus, preferentially with copper and/or manganese, and also preferentially co-doped with at least one of the elements selected from the group consisting of chlorine, bromine, iodine and aluminium (as luminous substance), BaTiO₃ and highly flexible binding agents, for example those based on PU, PMMA, PVA, in particular Mowiol and Poval from Kuraray Europe GmbH or Polyviol from Wacker AG, or PVB, in particular Mowital from Kuraray Europe GmbH, or Pioloform, in particular Pioloform BR18, BM18 or BT18, from Wacker AG.

Two formulations, particularly preferred in accordance with the invention, of a printing paste for producing the EL phosphorus layer by way of component DC contain:

| Substance | Content/wt. % | Content/wt. % | Content/wt. % |
|---|---|---|---|
| Pigment (Osram | 52.44 | 69.7 | 61.05 |
| Sylvania) | | | |
| Desmophen D670 | 21.19 | 11.88 | 12.8 |
| (BMS) | | | |
| Desmodur N75 MPA | 15.24 | 8.11 | 12.4 |
| (BMS) | | | |
| Ethoxypropyl acetate | 10.67 | 10 | 13.5 |
| Additol XL480 (50 | 0.46 | 0.3 | 0.25 |
| wt. % in Butoxyl) | | | |

In addition to components DA and DB, the electroluminescent element may contain an insulating layer by way of component DD, which is generally applied onto the layer containing at least one luminous substance that is capable of being excited by an electric field. Suitable material for an insulating layer is, for example, barium titanate (BaTiO₃). Further insulating materials are known to a person skilled in the art from the literature, for example: BaTiO₃, SrTiO₃, KNbO₃, PbTiO₃, LaTaO₃, LiNbO₃, GeTe, Mg₂TiO₄, Bi₂(TiO₃)₃, NiTiO₃, CaTiO₃, ZnTiO₃, Zn₂TiO₄, BaSnO₃, Bi(SnO₃)₃, CaSnO₃, PbSnO₃, MgSnO₃, SrSnO₃, ZnSnO₃, BaZrO₃, CaZrO₃, PbZrO₃, MgZrO₃, SrZrO₃, ZnZrO₃ or mixtures of two or more of these fillers. Preferred as filler in accordance with the invention in the paste for producing the insulating layer are BaTiO₃ or PbZrO₃ or mixtures thereof, preferentially in filling quantities from 5 to 80 wt. %, preferably from 10 to 75 wt. %, particularly preferably from 40 to 70 wt. %, in each case relative to the total weight of the paste.

By way of binding agent for this layer, use may be made of one-component or preferably two-component polyurethane systems, preferably from Bayer MaterialScience AG, once again particularly preferably Desmodur and Desmophen; from Degussa AG (Evonik), preferentially Vestanat, once again particularly preferably Vestanat T and B; or from the Dow Chemical company, once again preferably Vorastar.

By way of solvent, use may be made, for example, of ethyl acetate, butyl acetate, 1-methoxypropylacetate-2, toluene, xylene, Solvesso 100, Shellsol A or mixtures of two or more of these solvents. Moreover, additives such as levelling agents and rheological additives for improving the properties may also be added. Additol XL480 or Silquest A187, Neo Rez R986, Dynol 604 and/or mixtures of two or more of these substances in a quantity of preferentially 0.5 to 2.5 wt. %, in each case relative to the printing paste, are preferably included.

Two formulations, particularly preferred in accordance with the invention, of a printing paste for producing the insulating layer by way of component DD contain:

| Substance | Content/wt. % | Content/wt. % | Content/wt. % |
|---|---|---|---|
| BaTiO₃ | 50 | 60 | 55.3 |
| Desmophen 1800 | 25 | 13 | 20.1 |
| (BMS) | | | |
| Desmodur L67 | 13.7 | 13 | 9.4 |
| MPA/X (BMS) | | | |
| Ethoxypropyl acetate | 10 | 8 | 13.7 |
| Additol XL480 | 2.3 | 2 | 1.5 |

Moreover, the at least one electroluminescent element that is employed in accordance with the invention contains a back electrode, component DD. Said electrode is generally applied onto the insulating layer, if it is present. If no insulating layer is present, the back electrode is applied onto the layer containing at least one luminous substance that is capable of being excited by an electric field.

In the case of the back electrode it is a question—as in the case of the at least partly transparent electrode—of a planar electrode, which, however, does not have to be transparent or at least partly transparent. Said electrode is generally constructed from electrically conducting inorganically-based or organically-based materials, in which case preferably such materials are employed which are not damaged upon application of the isostatic high-pressure deformation process for producing the three-dimensionally deformed foil element according to the invention. Suitable electrodes are therefore, in particular, polymeric electrically conductive coatings. In this connection the coatings already named above with respect to the at least partly transparent electrode coatings may be employed. In addition, such polymeric electrically conductive coatings which are known to a person skilled in the art may be employed which are not at least partly transparent.

Suitable materials of the back electrode are consequently preferably selected from the group consisting of metals such as silver, carbon, ITO screen-printing layers, ATO screen-printing layers, non-ITO screen-printing layers—that is to say, intrinsically conductive polymeric systems with, ordinarily, nanoscale electrically conductive pigments, for example ATO screen-printing pastes having the designation 7162E or 7164 from DuPont, intrinsically conductive polymer systems such as the Orgacon® system from Agfa, the Baytron° poly(3,4-ethylenedioxythiophene) system from H. C. Starck GmbH, the system designated as organic metal (PEDT conductive polymer, polyethylenedioxythiophene) from Ormecon, conductive coating systems and printing-ink systems from Panipol Oy and, where appropriate, with highly flexible binding agents, for example based on PU (polyurethanes), PMMA (polymethyl methacrylate), PVA (polyvinyl alcohol), modified polyaniline, whereby the materials named above may be added to metals such as silver or carbon for the purpose of improving the electrical conductivity and/or may be supplemented with a layer consisting of these materials.

The formulation of the printing paste for the back electrode may correspond to that of the partly transparent electrode.

Departing from this formulation, however, the following formulation may also be used in accordance with the invention for the back electrode.

For the purpose of formulating a printing paste for producing the back electrode, use is made of 30 to 90 wt. %, preferably 40 to 80 wt. %, particularly preferably 50 to 70 wt. %, in each case relative to the total weight of the printing paste, of the conductive polymers Baytron P, Baytron PH, Baytron P AG, Baytron P HCV4, Baytron P HS, Baytron PH, Baytron PH 500, Baytron PH 510 or arbitrary mixtures thereof. By way of solvent, use may be made of dimethyl sulfoxide (DMSO), N,N-dimethylformamide, N,N-dimethylacetamide, ethylene glycol, glycerol, sorbitol, methanol, ethanol, isopropanol, N-propanol, acetone, methyl ethyl ketone, dimethylaminoethanol, water or mixtures of two or three or more of these solvents. The quantity of solvent used may vary within wide ranges. Accordingly, in one formulation, according to the invention, of a paste 55 to 60 wt. % solvent may be included, whereas in another formulation according to the invention about 40 wt. % of a solvent mixture consisting of three solvents are used. Furthermore, Silquest A187, Neo Rez R986, Dynol 604 or mixtures of two or more of these substances, preferentially in an quantity from 0.7 to 1.2 wt. % may be included as interface additive and adhesion activator. By way of binding agent, 0.5 to 1.5 wt. % UD-85, Bayhydrol PR340/1, Bayhydrol PR135 or arbitrary mixtures thereof, for example, may be included.

In another embodiment according to the invention the back electrode may be filled with graphite. This can be achieved by graphite being added to the formulations described above.

Departing from the formulations, stated above, for the back electrode, the following ready-made, commercially obtainable printing pastes named here in exemplary manner can also be employed in accordance with the invention as finished formulations: the Orgacon EL-P1000, EL-P3000, EL-P5000 or EL-P6000 series from Agfa, preferably the EL-P3000 and EL-P6000 series (for deformable uses). Here too, graphite may be added.

Especially for the back electrode, use may be made of the printing pastes of the Orgacon EL-P4000 series, in particular Orgacon EL-P4010 and EL-4020. These two may be mixed together in arbitrary ratio. Orgacon EL-P4010 and EL-4020 already contain graphite.

Purchasable graphite pastes may also be used as back electrode, for example graphite pastes from Acheson, in particular Electrodag 965 SS or Electrodag 6017 SS.

One formulation, particularly preferred in accordance with the invention, of a printing paste for producing the back electrode DE contains:

| Substance | Content/wt. % | Content/wt. % |
|---|---|---|
| Baytron P HS | 58.0 | 64.0 |
| Silquest A187 | 2.0 | 1.6 |
| NMP (e.g. BASF) | 17.0 | 14.8 |
| DEG | 10.0 | 5.9 |
| DPG/DMM | 10.0 | 10.2 |
| UD-85 | 3.0 | 3.5 |

Production of the electroluminescent element can be effected, for example, by application of the individual layers by the so-called thick-film process known in the state of the art.

Application of the layers of the electroluminescent element onto foil C is effected by processes known to a person skilled in the art. Connection of the electroluminescent element to foil C is generally effected by direct application, for example by screen printing, onto foil C.

For the purpose of contacting the electrically conductive layers DA and DE and supplying them with electric current, the two layers are preferentially provided with an arbitrarily configured conductor track. This can be effected for both layers in one printing, or for the front and rear electrodes in two individual printing processes. By way of printing paste, use may be made of the commercially obtainable systems known to a person skilled in the art, for example the silver conductive pastes from Acheson, such as Electrodag 725A (6S-61), Electrodag 418 SS or Electrodag PF-410.

### Component E

In addition to components A, B, C and D, the foil element according to the invention contains a protective layer, component EA, in order to avoid a destruction of the electroluminescent element or of the graphical representations that are present where appropriate. Suitable materials of the protective layer are known to a person skilled in the art. Suitable protective layers EA are, for example, high-temperature-resistant protective lacquers such as protective lacquers that contain polycarbonates and binding agents. An example of such a protective lacquer is Noriphan® HTR from Pröll, Weiβenburg.

Alternatively, the protective layer may also be formulated on the basis of polyurethanes. For this purpose, use may be made of polyurethanes from Bayer MaterialScience AG. This formulation may also be provided with fillers. Suitable for this are all the fillers known to a person skilled in the art, for example based on inorganic metal oxides such as TiO₂, ZnO, lithopones, etc. Furthermore, the formulations may contain levelling agents and also rheological additives. By way of solvent, use may be made, for example, of ethoxypropyl acetate, ethyl acetate, butyl acetate, methoxypropyl acetate, acetone, methyl ethyl ketone, methyl isobutyl ketone, cyclohexanone, toluene, xylene, solvent naphtha 100 or mixtures of two or more of these solvents.

One formulation, particularly preferred in accordance with the invention, of the protective lacquer EA contains:

| Substance | Content/wt. % |
|---|---|
| Desmodur | 18 |
| Additol XL480 | 1 |
| Desmophen | 21.85 |
| Ethoxypropyl acetate | 4.15 |
| TiO₂ | 55 |

Depending upon use, in addition to components A, B, C and D the foil element according to the invention may exhibit a foil, component EB, instead of the protective layer, component EA. Suitable foils are the foils named as carrier foils (component A). The foil may be applied, for example, by lamination or adhesive bonding.

The foil element according to the invention, which is generally flat, is three-dimensionally deformable by isostatic high-pressure deformation at a process temperature below the softening-temperature of components A and C, whereby a corresponding three-dimensionally deformed foil element is obtained. A suitable isostatic high-pressure deformation process is mentioned, for example, in EP-A 0 371 425. By virtue of the construction, according to the invention, from components A, B, C, D and E, which are described above, it is guaranteed that a three-dimensional deformation of the foil element according to the invention, which is generally flat, can be effected by means of isostatic high-pressure deformation without damage to the individual components of the foil element, in particular without impairment of the lamp function or of the semitransparent reflecting layer of the electroluminescent element.

The layers (components A, B, C, D and E) in the foil element according to the invention are matched in such a way that short-circuits are avoided. The protective layer, component E, on the rear has the effect that a crack-resistant deformation is possible. Since a generally flat foil element constructed from elements A, B, C, D and E is deformed by means of isostatic high-pressure deformation, it is of particular importance that a good adhesion of the individual layers of the foil element is guaranteed. The good adhesion is guaranteed by the composition of the individual layers (components A, B, C, D and E), in particular by the use of highly flexible binding agents in the layers, for example binding agents based on PU, PMMA, PVA. The composition of the layers (components A, B, C, D and E) guarantees not only an outstanding adhesion of the layers amongst themselves, but also an extensibility that is required for carrying out the isostatic high-pressure deformation.

A further subject of the present invention is consequently a three-dimensionally deformed foil element constructed from a foil element according to the invention comprising components A, B, C, D and E, producible by isostatic high-pressure deformation of the foil element according to the invention at a process temperature below the softening-temperature of components A and C of the foil element according to the invention.

Preferred components A, B, C, D and E and also preferred embodiments of the foil element according to the invention are named above.

The three-dimensional foil element according to the invention is distinguished by the fact that the at least one electroluminescent element applied onto the carrier foil and also the graphical representations that are present, where appropriate, on the transparent carrier foil are applied in positionally accurate manner. This is essential, since the three-dimensionally deformed foil element according to the invention is to serve, for example, for forming surfaces, in which case an exact positioning of the information symbols may be important. Such an exact positioning is achieved by a flat foil element being provided that exhibits components A, B, C, D and E, these components having been selected in such a way that the flat foil element can be three-dimensionally deformed by isostatic high-pressure deformation. It has been found that such a three-dimensional deformation by means of isostatic high-pressure deformation is possible in the presence of an electroluminescent element that exhibits components DA, DB, where appropriate DC and DD, and in the presence of a semitransparent metal foil B.

The three-dimensionally deformed foil elements according to the invention are sufficiently dimensionally stable for numerous applications, so that an in-mould decoration of the foil element with a suitable plastic, as proposed in the state of the art cited above, is not necessary. In a preferred embodiment, the present invention therefore relates to a three-dimensionally deformed foil element constructed from components A, B, C, D and E, the three-dimensionally deformed foil element not exhibiting any moulded-on substrate, in particular not being in-mould decorated with a plastic.

In another preferred embodiment, however, it may be sensible for the foil element to be in-mould decorated with a plastic. This will be the case in particular if stringent demands are made of the three-dimensional stability of the overall structural part and/or a high resistance to external applications of force is demanded. This may be the case, for example in housing lids, panels and covers.

The foil element according to the invention, which is generally flat, can be produced in accordance with processes known to a person skilled in the art.

In a preferred embodiment, the process for producing the foil element according to the invention (prior to the three-dimensional deformation) comprises the following steps:
ia) providing an at least partly transparent carrier foil A and, where appropriate, imprinting the transparent carrier foil with graphical representations,
ib) applying a semitransparent reflecting layer B onto the at least partly transparent carrier foil A,
ic) applying an at least partly transparent foil C onto the semitransparent reflecting layer B and, where appropriate, application of a graphic onto the at least partly transparent foil C,
id) applying at least one electroluminescent element D onto the at least partly transparent foil C,
ie) applying a protective layer EA or foil EB onto the at least one electroluminescent element D.

### Step ia)

Production of the at least partly transparent carrier foil A and of the at least partly transparent foil C, which are employed in step ia) and step ic), respectively, is effected in accordance with processes known to a person skilled in the art. Moreover, suitable carrier foils A and foils C are commercially obtainable.

Application of graphical representations onto the carrier foil A can likewise be effected by processes known to a person skilled in the art, for example by screen printing, offset lithography, rotary printing, gravure printing, inkjet, tampon printing, laser printing or flexographic printing, which are all customary and known in the state of the art. The graphic design is preferably effected by application of ink by means of screen printing.

In order to obtain a complete covering without extremely small transparent voids, a multiple printing can be effected, for example a twofold printing. For the positioning of the individual prints, in general use is made of reference marks or a three-point edge registration.

### Step ib)

The semitransparent reflecting layer B can be applied onto the carrier foil A by processes known to a person skilled in the art. Suitable processes for applying the semitransparent reflecting layer B are named above. Examples of suitable processes are PVD processes, CVD processes and other suitable processes.

### Step ic)

Onto the semitransparent reflecting layer B which has been applied onto the carrier foil A, which is provided with graphical representations where appropriate, in step ic) a further at least partly transparent foil C is applied.

Application can be effected by arbitrary processes known to a person skilled in the art. In a preferred embodiment of the present invention, application of foil C is effected by adhesive bonding. Suitable adhesive-bonding processes and adhesives are known to a person skilled in the art.

Onto foil C a graphic may be applied, where appropriate on the rear. This graphic may be applied by processes known to a person skilled in the art, for example by screen printing, offset lithography, rotary printing, gravure printing, inkjet, tampon printing, laser printing or flexographic printing, which are all customary and known in the state of the art. The graphic design is preferably effected by application of ink by means of screen printing.

In order to obtain a complete covering without extremely small transparent voids, a multiple printing, for example a twofold printing, can be effected. For the positioning of the individual prints, in general use is made of reference marks or a three-point edge registration.

### Step id)

Application of the electroluminescent element D onto foil C in step id) can likewise be effected by processes known to a person skilled in the art. Connection of the electroluminescent element D to foil C can be effected by means known to a person skilled in the art, in general by direct application, for example by screen printing, onto the carrier foil, as has already been mentioned above.

### Step ie)

In step ie) the protective layer EA or foil EB is likewise applied onto the at least one electroluminescent element by processes known to a person skilled in the art, preferably likewise by means of screen printing.

The insulating layers are likewise preferably applied by means of screen printing.

One advantage of the foil element according to the invention is that all the layers of the EL lamp and also of the, where appropriate, requisite graphic printing of the foil element are selected in such a way that they can be applied by screen printing. In a preferred embodiment of the process according to the invention, the imprinting, which is carried out where appropriate, of the transparent carrier foil with graphical representations in step ia), the application of the electroluminescent element onto the, where appropriate, imprinted carrier foil in step id), and the application of the protective layer onto the electroluminescent element in step ie) are effected by means of screen printing. Steps ib) and ic) are generally carried out in separate steps, by means of processes known to a person skilled in the art. Where required, step ia) may also be carried out after step ic), in order to optimise the process chain.

The foil element according to the invention is suitable for producing three-dimensionally deformed foil elements by means of the isostatic high-pressure process.

A further subject of the present invention is consequently a process for producing a three-dimensionally deformed foil element, comprising:
i) production of a foil element according to the invention,
ii) isostatic high-pressure deformation of the foil element according to the invention obtained in step i) at a process temperature below the softening-temperature of components A and C of the foil element,
iii) where appropriate, in-mould decoration of the foil element according to the invention obtained in step ii).

In the case of the foil element according to the invention it is ordinarily a question of a flat foil element.

### Step i)

Step i) relates to the production of the foil element according to the invention. Step i) is preferably effected by a process comprising steps ia), ib), ic), id) and ie). The individual process steps ia) to ie) have already been described above.

Components A, B, C, D and E have the meanings already stated above. In addition to components A, B, C, D and E, the three-dimensionally deformed foil element according to the invention may contain further layers where appropriate.

### Step ii)

The isostatic high-pressure deformation in step ii) is preferably effected in accordance with the process stated in EP-A 0 371 425, whereby a process temperature is selected that lies below the softening-temperature of components A and C of the foil element.

In general, the foil element according to the invention, which is obtained in step i), is constructed from components A, B, C, D and E, is subjected at a working temperature to the action of a fluid pressure medium and isostatically deformed, the deformation being performed at a working temperature below the softening-temperature of the material of the carrier foil A and of foil C and under a pressure-medium pressure of generally >20 bar, preferably >100 bar, particularly preferably from 200 bar to 300 bar. Deformation of the foil material is generally effected within a few seconds of cycle time, preferably within a time-interval of <10 seconds, particularly preferably within a time-interval of <5 seconds. In this connection, deformations from 100% to 200% can be obtained, without occurrence of optically interfering stress-whitening.

In a preferred embodiment, the isostatic high-pressure deformation is generally effected at least 5° C., preferably at least 10° C., particularly preferably at least 20° C. and more, below the softening-temperature of component A of the foil element. The softening-temperature of polycarbonates based on bisphenol A (for example, Makrofol® foils) that are employed in particularly preferred manner as material of the at least partly transparent carrier foil lies around or above 150° C. It is possible for the isostatic high-pressure deformation of foil elements that exhibit such polycarbonate foils as carrier foils to be carried out at room temperature. By reason of the further components, inter alia by reason of the graphical representations which are preferably effected by means of colour overprinting, the isostatic high-pressure deformation is preferably effected at working temperatures between 80° C. and 130° C. if polycarbonates based on bisphenol A, as mentioned above, are employed as foil material of the carrier foil. In the case where carrier foils consisting of other materials are employed, given knowledge of the softening-temperature of the material the processing temperature in step ii) can be ascertained without difficulty for the person skilled in the art.

Suitable apparatuses for implementing the isostatic high-pressure deformation for producing the three-dimensionally deformed foil element according to the invention are named in EP-A 0 371 425, for example.

The three-dimensionally deformed foil element obtained subsequent to step ii) can be brought into a definitive desired contour by trimming, punching or lasing, for example. Suitable processes and apparatuses in order to bring the foil element into its definitive contour—for example, by punching, trimming or lasing—are known to a person skilled in the art. In general, punching, trimming or lasing is effected with high precision, a suitable process for trimming being, for example, precision cutting.

Step iii)

The previously described foil element containing at least one electroluminescent device already has a sufficient rigidity and dimensional stability for many applications.

For certain applications, however, it may be necessary for the deformed foil element that has been brought into shape to be in-mould decorated, in order to achieve a rigidity that satisfies the demands made of the finished part.

In-mould decorating is generally effected in accordance with the injection-moulding process for imprinted and preformed foil elements, which is known to those skilled in the art, inter alia, by the terms ‘in-mould decoration’ (IMD), ‘in-mould labelling’ (IML) or ‘film-insert moulding’ (FIM).

The foil element according to the invention, which is generally flat, and the three-dimensionally deformed foil element according to the invention can be employed in numerous applications. Suitable applications are, for example, the use of the foil elements according to the invention for forming decorative panels and covers or display elements for land vehicles, watercraft and aircraft, for forming safety-belt panels or warning-indication panels in land vehicles, watercraft and aircraft, and for forming warning-indication panels in buildings, for forming housing elements for mobile electronic instruments, for example a mobile phone or a remote control, and for forming housing elements for stationary electronic instruments such as a printer, copier, PC, notebook, or for forming a small or large household appliance, or for forming a keyboard.

1.-15. (canceled)

16. A foil element constructed from
a) at least partly transparent carrier foil, component A, which comprise at least one cold-stretchable foil material which is provided with optional graphical representations,
b) a semitransparent reflecting layer B,
c) at least partly transparent foil comprising at least one cold-stretchable foil material, component C,
d) at least one electroluminescent element, component D, applied onto the at least partly transparent foil C, containing the following components
da) an at least partly transparent electrode, component DA,
db) optionally a first insulating layer, component DB,
dc) a layer, component DC, containing at least one luminous substance that is capable of being excited by an electric field,
dd) optionally a further insulating layer, component DD, and
de) a back electrode, component DE,
e) a protective layer, component EA, or a foil, component EB.

17. The foil element according to claim 16, wherein the foil material of the carrier foil A and of foil C is selected from at least one material selected from the group consisting of a polycarbonate, a polyester, a polyamide, a polyimide, a polyarylate, an organic thermoplastic cellulose ester and a polyfluorohydrocarbon.

18. The foil element according to claim 16, wherein the foil material of the carrier foil A and of foil C is selected from at least one material selected from the group consisting of a polycarbonate, a polyester and a polyimide.

19. The foil element according to claim 16, wherein the carrier foil A and/or foil C is/are provided with graphical representations in the form of opaque or translucent color overprints.

20. The foil element according to claim 16, wherein the semitransparent reflecting layer B exhibits a transmission in respect of visible light from 5% to 60%.

21. The foil element according to claim 18, wherein the carrier foil A and/or foil C is/are provided with graphical representations in the form of opaque or translucent color overprints and the semitransparent reflecting layer B exhibits a transmission in respect of visible light from 10 to 40%.

22. The foil element according to claim 16, wherein at least one metal selected from the group consisting of aluminium, magnesium, tin, gold, silver, copper, zinc, nickel, chromium, cobalt, manganese, lead, titanium, iron and tungsten, or a metallic ink, is employed by way of metal forming the semitransparent reflecting layer.

23. The foil element according to claim 21, wherein at least one metal selected from aluminium or chromium is employed by way of metal forming the semitransparent reflecting layer.

24. The foil element according claim 16, wherein that at least one electroluminescent element exhibits electrical terminals.

25. The foil element according to claim 16, wherein that the at least one electroluminescent element is operated by means of alternating current and said alternating current is generated by means of an EL inverter.

26. The foil element according to claim 16, wherein the foil element exhibits in addition to components A, B, C, D and E at least one LED element, by way of component F.

27. The foil element according to claim 23, wherein the foil element exhibits in addition to components A, B, C, D and E at least one SMD LED element, by way of component F.

28. The foil element according to claim 16, wherein the at least partly transparent electrode DA of the electroluminescent element D is a planar electrode constructed from an electrically conductive material selected from the group consisting of ITO screen-printing layers, ATO screen-printing layers, non-ITO screen-printing layers and intrinsically conductive polymer systems.

29. The foil element according to claim 16, wherein the layer DC containing at least one luminous substance that is capable of being excited by an electric field contains ZnS, generally doped with phosphorus, by way of luminous substance.

30. The foil element according to claim 16, wherein the back electrode DE of the electroluminescent element D is a planar electrode constructed from electrically conductive materials selected from the group consisting of metals such as silver, carbon, ITO screen-printing layers, ATO screen-printing layers, non-ITO screen-printing layers and intrinsically conductive polymer systems, whereby for the purpose of improving the electrical conductivity the materials may be added to metals such as silver or carbon and/or is optionally supplemented with a layer consisting of these materials.

31. A three-dimensionally deformed foil element that is capable of being produced by isostatic high-pressure deformation of the foil element according to claim 16 at a process temperature below the softening-temperature of components A and C of the foil element.

32. A process for producing a foil element according to claim 16, comprising
ia) providing an at least partly transparent carrier foil A and optionally imprinting the transparent carrier foil with graphical representations,
ib) applying a semitransparent reflecting layer B onto the at least partly transparent carrier foil,
ic) applying an at least partly transparent foil C onto the semitransparent reflecting layer and optionally applying a graphic onto the at least partly transparent foil C,
id) applying the at least one electroluminescent element D onto the at least partly transparent foil,
ie) applying the protective layer EA or foil EB onto the at least one electroluminescent element.

33. A process for producing a three-dimensionally deformed foil element, comprising
i) producing the foil element according to the process according to claim 32,
ii) isostatic high-pressure deformation of the foil element obtained in step i) at a process temperature below the softening-temperature of components A and C of the foil element, and
iii) optionally in-mold decoration of the foil element obtained in step iii).

34. An article which comprises the foil element as claimed in claim 16, wherein the article is a decorative panel, a decorative cover, a display element for a land vehicle, a display element for a watercraft, a display element for an aircraft, a safety-belt panel, a warning-indication panel in a land vehicle, a warning-indication panel in a watercraft, a warning-indication panel in an aircraft, a warning-indication panel in a building, a housing element for a mobile electronic instrument, a housing element for a stationary electronic instrument, a household appliance or a keyboard.
